(19) United States
(12) Patent Application Publication
(10) Pub. No.: US 2020/0288024 A1
(43) Pub. Date: Sep. 10, 2020

(54) Image Reading Device and Image Reading Method

(71) Applicant: Konica Minolta, Inc., Tokyo (JP)

(72) Inventor: Toshinobu Yamaguchi, Osaka (JP)

(73) Assignee: Konica Minolta, Inc., Tokyo (JP)

(21) Appl. No.: 16/805,992

(22) Filed: Mar. 2, 2020

(30) Foreign Application Priority Data
Mar. 4, 2019 (JP) 2019-038262

(51) Int. Cl. H04N 1/00

(52) U.S. Cl. CPC H04N 1/00244; H04N 1/00514; H04N 1/00411; H04N 1/00811

(57) ABSTRACT

An image reading device that connects to a network, the image reading device exemplarily including: an operation panel that has a display; a document reader that generates scan data by reading a document placed on a document plate when a scan instruction specifying a save destination is received from an information terminal via the network; and a controller. The controller may cause display of the save destination on the display, which may be ready to receive a panel operation via the operation panel to execute a process for transmitting the scan data to the save destination, and upon receiving the panel operation, may execute the process for transmitting the scan data to the save destination.

### CROSS REFERENCE TO RELATED APPLICATIONS

This application claims priority to Japanese Patent Application No. 2019-038262 filed Mar. 4, 2019, the content of which is hereby incorporated herein by reference in its entirety.

### BACKGROUND

### Technical Field

The present disclosure relates to image reading devices that have a remote scan function of receiving instructions for scan jobs via a network and executing received scan jobs.

### Description of Related Art

Development of image reading devices and communication technology has led to use of remote scanning, which here means performing a scan job remotely via a network. When remote scanning is used, a user can execute scanning by an image reading device by using a smartphone or the like from a remote location.

A communication terminal such as a smartphone may provide a remote scan function as a standard operating system (OS) function. In such a case, an application running on the communication terminal can capture and use scan data generated by an image reading device using a remote scan function protocol provided as a standard function of the OS.

Using remote scanning has the following security problem. If a user B executes a remote scan at the same timing as a user A setting a document on an image reading device, the user B may be able to acquire scan data of user A's document.

JP 2016-63435 describes a structure that performs a document authenticity determination process to determine whether or not a document set on an image reading device is a document of a user of a terminal that provided a remote scan instruction, and executes the scan if it is determined that the document set on the image reading device is a document of the user of the terminal that provided the remote scan instruction.

According to the document authenticity determination process of JP 2016-63435, when a document is set, if identification information of a portable terminal in the vicinity of the image reading device matches identification information of the terminal that provided the remote scan instruction, it is determined that the set document is a document of the user of the terminal that provided the remote scan instruction. As another method, when a time of detection of setting the document and a time of reception of the remote scan instruction are within a defined time period, it is determined that the set document is a document of the user of the terminal that provided the remote scan instruction. According to the former method, terminals that can execute remote scanning are limited to terminals that can execute direct wireless communication with the image reading device. Further, there is a possibility than scan data could be acquired when a malicious user possesses a terminal that can execute direct wireless communication with the image reading device and waits in advance in the vicinity of the image reading device. The latter method also allows the possibility that a malicious user can acquire scan data by transmitting the remote scan instruction to the image reading device at the same timing as the setting of the document.

Further, J P 2009-267701 describes an exclusive control in which a delivery destination is set prior to setting a document, and a scan instruction from a source other than the delivery destination is not accepted.

According to JP 2009-267701, transmission of scan data to a destination other than a set delivery destination can be avoided by the following steps: (1) setting the delivery destination using an operation panel or remote terminal (exclusive control start), (2) setting a document, and (3) providing a remote scan instruction. However, due to factors like human error, there is a risk that a document is set before a delivery destination is set. At such time, there is a possibility that a malicious user can acquire scan data by executing a remote scan between the setting of the document and the setting of the delivery destination.

### SUMMARY

The present disclosure has an object of providing an image reading device and method that can prevent unauthorized acquisition of scan data by a user who is not an owner of a scanned document.

According to an aspect of the present disclosure, an image reading device reflecting one aspect of the present disclosure may be an image reading device that may connect to a network, the image reading device exemplarily including: an operation panel that has a display; a document reader that generates scan data by reading a document placed on a document plate, when a scan instruction specifying a save destination is received from an information terminal via the network; and a controller. The controller may cause display of the save destination on the display, which may be ready to receive a panel operation via the operation panel to execute a process for transmitting the scan data to the save destination, and may, upon receiving the panel operation, execute the process for transmitting the scan data to the save destination.

Further, an image reading method reflecting one aspect of the present disclosure may be an image reading method executed by an image reading device that may include an operation panel that has a display, a document reader, and a controller, and may have a function of connecting to a network. The method may include: the document reader generating scan data by reading a document placed on a document plate, when a scan instruction specifying a save destination is received from an information terminal via the network; the controller causing display of the save destination on the display, which may be ready to receive a panel operation via the operation panel to execute a process for transmitting the scan data to the save destination; and the controller, upon receiving the panel operation, executing the process for transmitting the scan data to the save destination.

According to the above, an outstanding effect is achieved of preventing unauthorized acquisition of scan data by a user who is not the owner of a document.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the disclosure. In the drawings:

FIG. 1 is a system diagram illustrating a configuration of an image forming system 1 pertaining to at least one embodiment;

FIG. 2 is a block diagram illustrating structure of a control device 14;

FIG. 3A is a block diagram illustrating functional structure of a main controller 110 and FIG. 3B is a block diagram illustrating functional structure of a hard-disk drive (HDD) 114;

FIG. 4 is a flowchart (1) illustrating operations of the image forming system 1;

FIG. 5 is a diagram illustrating an example structure of a remote scan instruction;

FIG. 6 is a block diagram illustrating functional structure pertaining to execution of a scan job;

FIG. 7 is a block diagram illustrating functional structure pertaining to generation and display of a save destination confirmation screen;

FIG. 8 is a diagram illustrating an example save destination confirmation screen displayed on a display 18;

FIG. 9 is a block diagram illustrating functional structure pertaining to transmission of scan data;

FIG. 10 is a block diagram illustrating functional structure pertaining to user authentication;

FIG. 11 is a block diagram illustrating functional structure pertaining to generation and transmission of a substitute image;

FIG. 12 is a diagram illustrating an example of a substitute image generated by the image forming device 10;

FIG. 13 is a flowchart (2) illustrating operations of the image forming system 1;

FIG. 14 is a block diagram illustrating functional structure pertaining to identity verification processing;

FIG. 15 is a diagram illustrating an example personal identification number (PIN) input screen displayed on the display 18;

FIG. 16 is a diagram illustrating an example acquisition method description screen displayed on the display 18;

FIG. 17 is a block diagram illustrating functional structure pertaining to transmission of scan data; and

FIG. 18 is a diagram illustrating an example save destination confirmation screen displayed on the display 18.

### DETAILED DESCRIPTION

Hereinafter, one or more embodiments of the present disclosure will be described with reference to the drawings. However, the scope of the disclosure is not limited to the disclosed embodiments.

### 1. Embodiments

The following describes an image forming system 1 as an embodiment of the present disclosure with reference to the drawings.

### 1.1. Configuration of Image Forming System 1

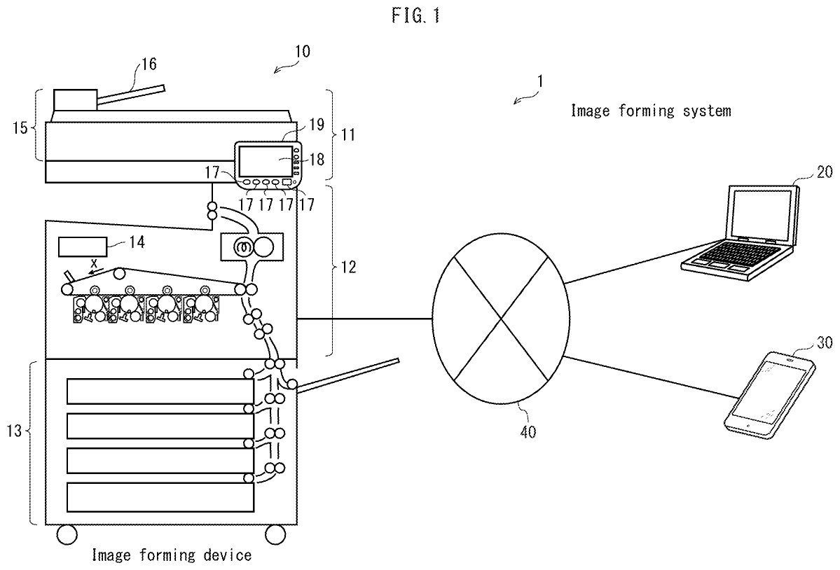

The image forming system 1, as illustrated in FIG. 1, includes an image forming device 10, a communication terminal 20, and a portable terminal 30.

The image forming device 10 is connected by a network 40 to the communication terminal 20 and the portable terminal 30. The network 40 includes a communication network such as a local area network (LAN).

The image forming device 10 is a tandem-type color multi-function peripheral (MFP) that includes scanner, printer, and copier functions.

The image forming device 10, as illustrated in FIG. 1, includes a sheet feeder 13 that stores and feeds sheets in a lower portion of the body of the image forming device 10. Above the sheet feeder 13 is a printer 12 that forms images by electrophotography. Above the printer 12 is a scanner 11 that reads a document surface and generates image data, and an operation panel 19 that displays an operation screen and accepts input operations from a user.

The scanner 11 includes an automatic document feeder 15. The automatic document feeder 15 conveys documents set on a document tray, one sheet at a time, to a document glass plate. The scanner 11 scans (reads) an image of a document conveyed to a defined position on the document glass plate by the automatic document feeder 15 by moving the scanner, and acquires image data consisting of a red (R), green (G), and blue (B) multi-value digital signal. The scanner 11 writes acquired image data to an HDD 114 (described later). Upon detecting that a document has been set on document tray 16, the scanner 11 notifies the control device 14.

Each color component of image data acquired by the scanner 11 is subjected to various data processes in the control device 14, and further converted to yellow (Y), magenta (M), cyan (C), and black (K) reproducible color image data.

The printer 12 includes an intermediate transfer belt, a drive roller, a driven roller, and a backup roller that keep the intermediate transfer belt taut, and imaging units, fixing units, and the like facing the intermediate transfer belt at defined intervals along a running direction X of the intermediate transfer belt.

Each imaging unit includes a photosensitive drum as an image carrier, a light-emitting diode (LED) array for exposing and scanning a surface of the photosensitive drum, a charger, a developing unit, a cleaner, and a primary transfer roller.

The sheet feeder 13 includes sheet feeding cassettes that can store sheets of different sizes, pickup rollers for feeding sheets from the sheet feeding cassettes to a conveyance path, a manual feed tray for placing sheets, and pickup rollers for feeding sheets from the manual feed tray to the conveyance path.

In each imaging unit, the photosensitive drum is uniformly charged by the charger and exposed by the LED array to form an electrostatic latent image on a surface of the photosensitive drum. The electrostatic latent image is developed by the developing unit of a corresponding color, forming a Y, M, C, or K color toner image on the surface of the photosensitive drum. Each toner image is sequentially transferred onto a surface of the intermediate transfer belt by electrostatic action of the primary transfer roller disposed on a reverse side of the intermediate transfer belt. Thus, a color toner image is formed on the surface of the intermediate transfer belt.

Timed to match the imaging operations of the imaging units, a sheet is fed from any one of the sheet feeding cassettes or the manual feed tray of the sheet feeder 13, conveyed on the conveyance path to a secondary transfer position where the secondary transfer roller and the backup roller sandwich the intermediate transfer belt, and at the secondary transfer position, the YMCK color toner image on the intermediate transfer belt is transferred to the sheet by electrostatic action of the secondary transfer roller. The YMCK color toner image on the sheet is further conveyed to the fixing unit.

When the YMCK color toner image on a surface of the sheet passes through a fixing nip of the fixing unit formed between a heating roller and a pressure roller pressed against the heating roller, the YMCK color toner image is fused to the surface of the sheet by heat and pressure. After passing through the fixing unit, the sheet is delivered to a discharge tray.

The operation panel 19 includes the display 18, which includes a liquid crystal display (LCD) panel or the like, and displays content set by a user and various messages. For example, when the image forming device 10 receives a remote scan instruction, the display 18 displays a save destination confirmation screen to confirm a save destination of scan data, a PIN code input screen to promote input of a PIN code for identity verification, and an acquisition method description screen describing a method of acquiring scan data, and the like.

Further, the operation panel 19 includes an input unit 17 that accepts a scan instruction, selection of a scan data save destination, PIN code input, and the like from a user. The input unit 17 may include a touch sensor provided on a surface of the display 18, a numeric keypad for numerical input (not illustrated), and the like. The operation panel 19 notifies the control device 14 of received input.

### 1.2. Control Device Structure

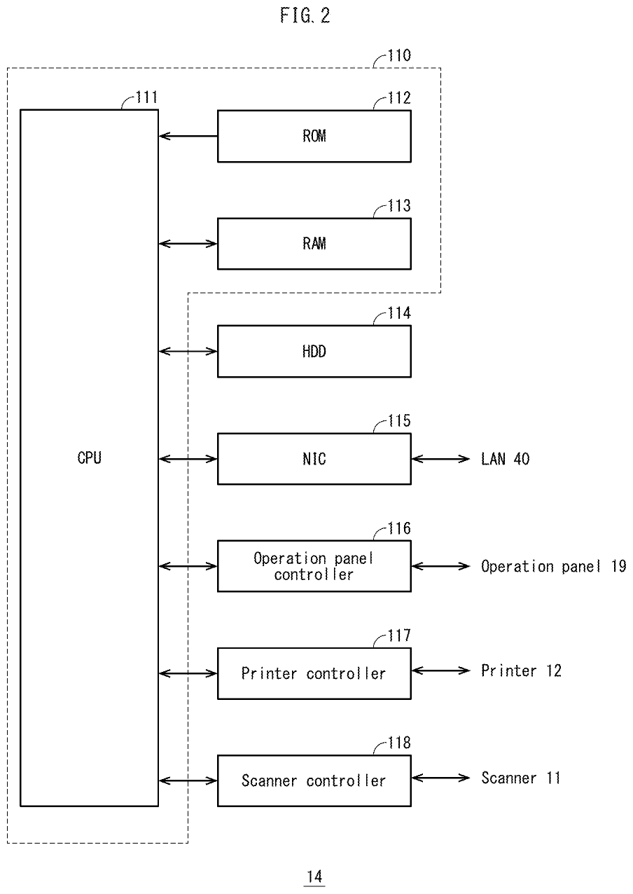

The control device 14, as illustrated in FIG. 2, includes a main controller 110, the HDD 114, a network interface card (NIC) 115, an operation panel controller 116, a printer controller 117, a scanner controller 118, and the like.

### (1) Main Controller 110

The main controller 110 includes a central processing unit (CPU) 111, a read-only memory (ROM) 112, a random access memory (RAM) 113, and the like.

The RAM 113 includes a semiconductor memory, temporarily stores various control variables, and provides a work area when the CPU 111 executes a program.

The ROM 112 includes a semiconductor memory, and stores in advance control programs and the like for executing various jobs such a scan job, a copy job, a print job, etc.

The CPU 111 includes a fetch unit, a decoding unit, an execution unit, a register file, an instruction counter, and the like. The fetch unit reads out each instruction code included in a control program stored in the ROM 112 one by one. The decoding unit decodes instruction codes that are read out. The execution unit executes operations according to decoding results. In this way, the CPU 111 operates according to control programs stored in the ROM 112.

As described above, the main controller 110 includes the CPU 111, the ROM 112, the RAM 113, etc., and uniformly controls the HDD 114, the NIC 115, the operation panel controller 116, the printer controller 117, the scanner controller 118, etc., according to a scan job, copy job, print job, or the like.

For example, according to an operation according to a control program, upon receiving a print job via the NIC 115, the main controller 110 instructs the printer controller 117 to cause the printer 12 to execute an image forming operation. Further, according to an operation according to a control program, upon receiving a scan job via the NIC 115, the main controller 110 instructs the scanner controller 118 to cause the scanner 11 to execute an image reading operation.

### (2) HDD 114

The HDD 114 is a hard disk drive that stores scan data obtained by the scanner 11, transmission source information, save destination information, authentication information (authentication ID, password), and job conditions included in a scan job received via the NIC 115, a display screen for display on the display 18 of the operation panel 19, and the like.

Further, the image forming device 10 provides, for example, a so-called “Box” function. Here, a “Box” function means that each user is provided with a personal “Box” storage region for storing and managing image data and the like.

Further, the HDD 114 stores authenticated user information (user registration information), and is used to determine whether or not a remote scan instruction is from an authenticated user by comparing authentication information included in the remote scan instruction to user registration information.

### (3) NIC 115

The NIC 115 receives a print job or a scan job from an external terminal device via the network 40. Further, as required, the NIC 115 outputs messages and the like to an external terminal device.

Further, the NIC 115 receives execution instructions and execution conditions of jobs of the image forming device 10 from the communication terminal 20 and the portable terminal 30 via the network 40, and outputs received execution instructions and execution conditions to the printer controller 117, the scanner controller 118, and the like. Thus, the image forming device 10 executes jobs received from the communication terminal 20 and the portable terminal 30.

### (4) Operation Panel Controller 116

The operation panel controller 116 relays data between the main controller 110 and the operation panel 19.

For example, the operation panel controller 116 receives a menu screen, an image, a message, or the like from the main controller 110, and outputs the received menu screen, image, message, or the like to the operation panel 19.

Further, the operation panel controller 116 receives execution instructions and execution conditions of jobs of the image forming device 10 from the operation panel 19, and outputs received execution instructions and execution conditions to the NIC 115, the printer controller 117, the scanner controller 118, or the like. Thus, the image forming device 10 executes jobs received via the operation panel 19.

Further, the operation panel controller 116 controls transitions of screens to be displayed on the display 18 of the operation panel 19.

### (5) Printer Controller 117

The printer controller 117 uniformly controls feed operations from the sheet feeder 13, imaging operations of imaging units of each developer color of the printer 12, and the like, and causes execution of image forming operations.

### (6) Scanner Controller 118

The scanner controller 118 controls scans of document surfaces by the scanner 11. For example, the scanner controller 118 specifies resolution when the scanner 11 scans a document surface. The scanner controller 118 writes image data (scan data) acquired from the scanner 11 to the HDD 114.

### 1.3. Functional Structure of Main Controller 110 and HDD 114.

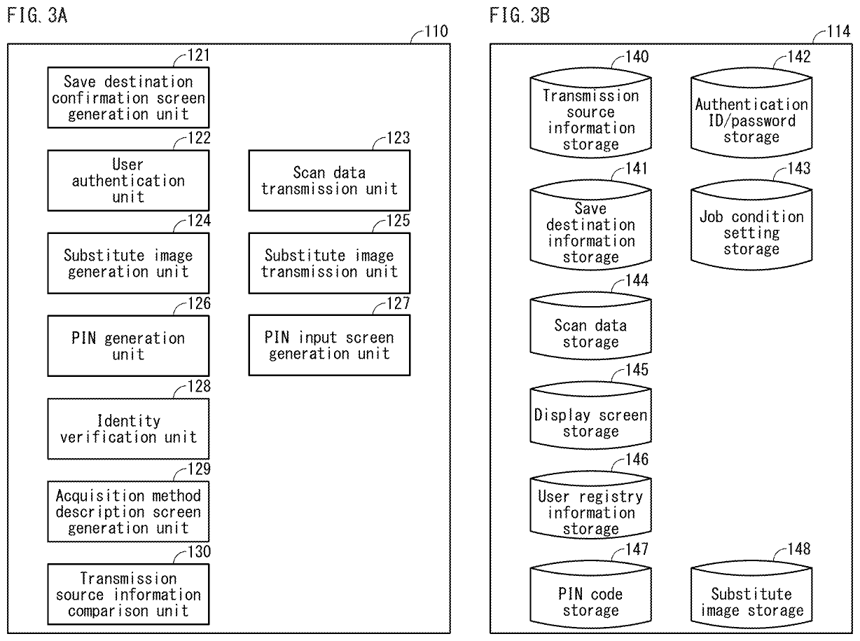

Functional structures of the main controller 110 and the HDD 114 are described with reference to FIG. 3A and FIG. 3B.

FIG. 3A illustrates an example of functional structure of the main controller 110. As illustrated, the main controller 110 includes a save destination confirmation screen generation unit 121, a user authentication unit 122, a scan data transmission unit 123, a substitute image generation unit 124, a substitute image transmission unit 125, a PIN generation unit 126, a PIN input screen generation unit 127, an identity verification unit 128, an acquisition method description screen generation unit 129, and a transmission source information comparison unit 130.

The save destination confirmation screen generation unit 121 has a function of generating save destination confirmation screen data to be displayed on the display 18 of the operation panel 19 when the image forming device 10 receives a remote scan instruction.

The user authentication unit 122 has a function of performing user authentication processing when a remote scan instruction includes authentication information (authentication ID and password).

The scan data transmission unit 123 has a function of transmitting scan data stored in the scan data storage 144 to a save destination indicated by save destination information stored in the save destination information storage 141.

The substitute image generation unit 124 has a function of generating substitute image data to be transmitted to a save destination instead of scan data when a remote scan instruction is determined to be from an unauthenticated user.

The substitute image transmission unit 125 has a function of transmitting substitute image data stored in the substitute image storage 148 to a save destination indicated by save destination information stored in the save destination information storage 141.

The PIN generation unit 126 has a function of generating a PIN code for identity verification.

The PIN input screen generation unit 127 has a function of generating PIN input screen data to be displayed on the display 18 of the operation panel 19 when a user is to input a PIN code.

The identity verification unit 128 has a function of performing identity verification by comparing a PIN code stored in the PIN code storage 147 to a PIN code inputted by a user via the input unit 17 of the operation panel 19.

The acquisition method description screen generation unit 129 has a function of generating acquisition method description screen data to be displayed on the display 18 of the operation panel 19 when identity verification is successful.

The transmission source information comparison unit 130 has a function of comparing two sequences of transmission source information stored in the transmission source information storage 140, to check whether or not two remote scan instructions were transmitted from the same terminal.

FIG. 3B illustrates an example of functional structure of the HDD 114. As illustrated, the HDD 114 includes a transmission source information storage 140, a save destination information storage 141, an authentication ID/password storage 142, a job condition setting information storage 143, a scan data storage 144, a display screen storage 145, a user registry information storage 146, a PIN code storage 147, and a substitute image storage 148.

The transmission source information storage 140 stores transmission source information included in a remote scan instruction. The save destination information storage 141 stores save destination information included in a remote scan instruction. The authentication ID/password storage 142 stores authentication information included in a remote scan instruction. The job condition setting information storage 143 stores job condition setting information included in a remote scan instruction.

The scan data storage 144 stores scan data acquired from the scanner 11.

The display screen storage 145 stores each type of screen to be displayed on the display 18 of the operation panel 19.

The user registry information storage 146 stores an authentication ID and password of an authenticated user.

The PIN code storage 147 stores a PIN code generated by the PIN generation unit.

The substitute image storage 148 stores substitute image data to be transmitted to a save destination instead of scan data when a remote scan instruction is determined to be from an unauthenticated user.

### 1.4. Communication Terminal 20, Portable Terminal 30

The communication terminal 20 and the portable terminal 30 are computer systems each including a microprocessor, a signal processor, ROM, RAM, and the like, that transmit instructions such as an instruction to remote scan or remote print to the image forming device 10.

The communication terminal 20, as one example, is a laptop computer, and the portable terminal 30, as one example, is a smartphone. Note that the communication terminal 20 may be a desktop computer or the like, and the portable terminal may be a tablet, mobile phone, or the like.

### 1.5. Operations of Image Forming System 1

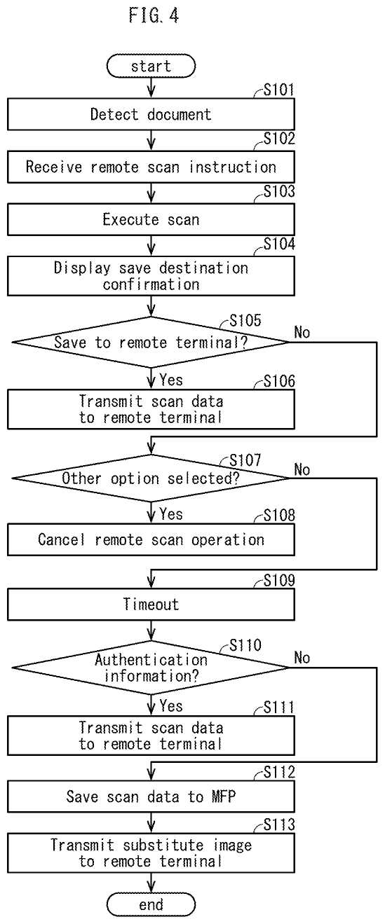

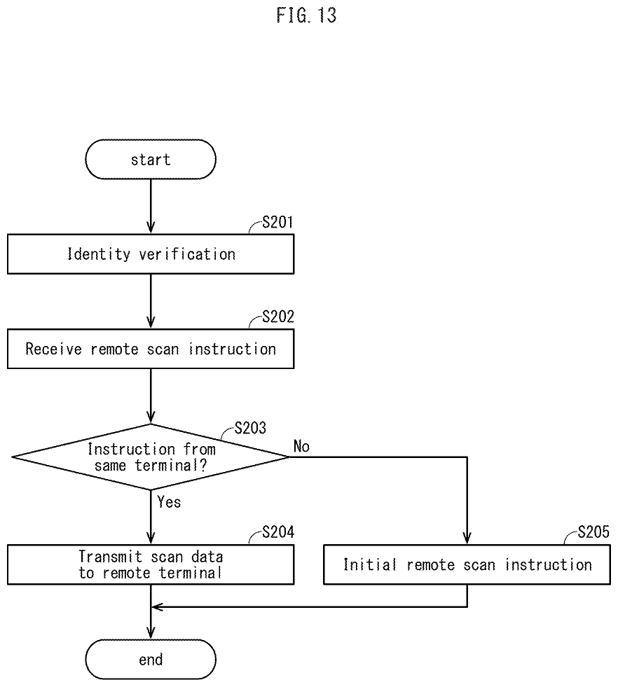

Operations of the image forming system 1 are described with reference to the flowcharts illustrated in FIG. 4 and FIG. 13.

When a user sets a document on the document tray of the image forming device 10, the scanner 11 detects that a document has been set and notifies the control device 14 (step S101).

When the main controller 110 receives a remote scan instruction from the communication terminal 20 or the portable terminal 30, transmission source information, save destination information, authentication ID/password, and job condition setting information included in the remote scan instruction are stored in the transmission source information storage 140, the save destination information storage 141, the authentication ID/password storage 142, and the job condition setting information storage 143, respectively (step S102).

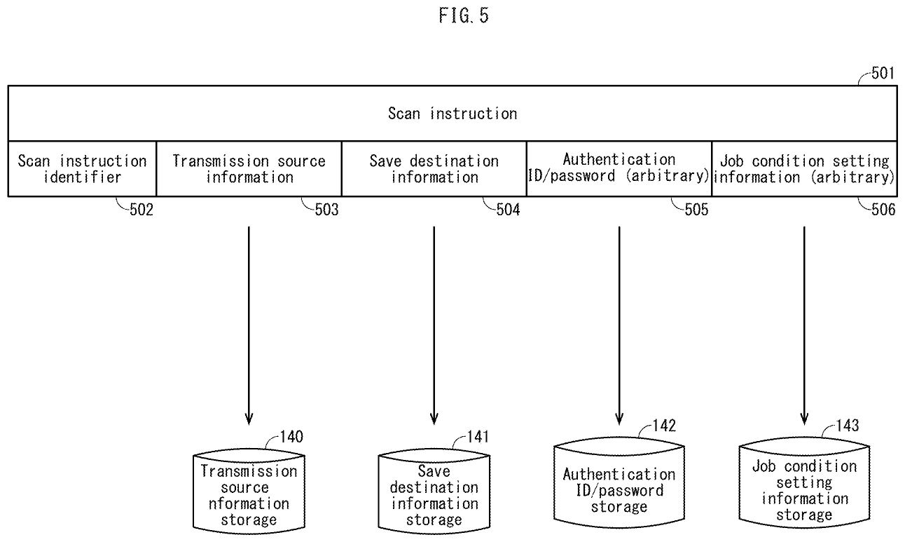

FIG. 5 illustrates an example of an instruction packet 501 used in a remote scan instruction. The instruction packet 501 includes a scan instruction identifier 502, transmission source information 503, save destination information 504, an authentication ID/password 505, and job condition setting information 506 as a payload.

The scan instruction identifier 502 is an identifier for identifying that a message received from the communication terminal 20 or the portable terminal 30 is a remote scan instruction.

The transmission source information 503 is information that identifies the communication terminal 20 or the portable terminal 30 that is the transmission source, and specifies the transmission source as a transmission destination to which the image forming device 10 transmits a response to the remote scan instruction.

The save destination information 504 is information that specifies a transmission destination of scan data generated according to the remote scan instruction.

The authentication ID/password 505 is an authentication ID and password used in user authentication. The authentication ID/password 505 is arbitrary, and when user authentication is unnecessary, the instruction packet 501 does not include the authentication ID/password 505.

The job condition setting information 506 is information that specifies job conditions when executing the scan job (such as file type, resolution, color setting, document size, brightness, contrast, double-sided reading, etc.) The job condition setting information 506 is arbitrary, and when the job condition setting information 506 is not included in the remote scan instruction, the scan job is executed using default settings.

Returning to FIG. 4, after receiving a remote scan instruction, the scanner 11 executes a scan job according to the job condition setting information 506 included in the instruction packet 501, and stores scan data in the scan data storage 144 (step S103).

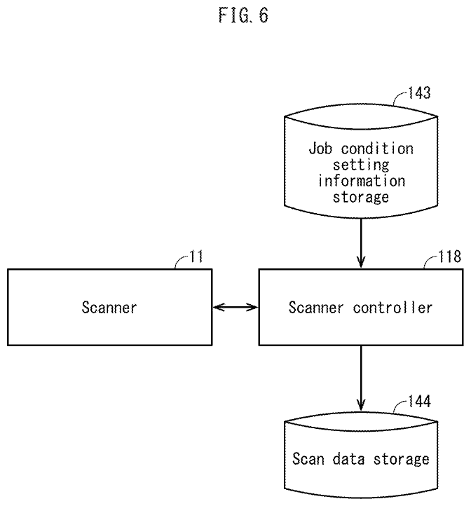

FIG. 6 is a block diagram illustrating functional structure pertaining to execution of a scan job in the image forming device 10. As illustrated, the scanner controller 118 reads the job condition setting information 506 from the job condition setting information storage 143, controls the scanner 11 to acquire scan data according to the job condition setting information read, and stores the scan data acquired in the scan data storage 144.

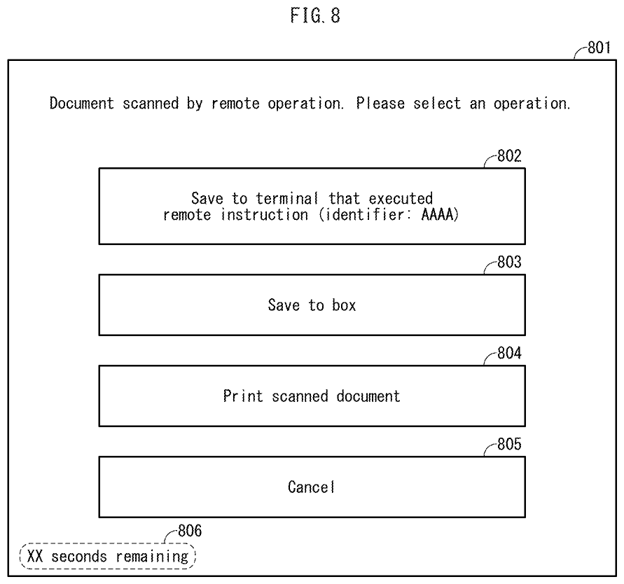

Returning to FIG. 4, after execution of the scan job, the save destination confirmation screen generation unit 121 generates a save destination confirmation screen 801, an example of which is illustrated in FIG. 8, and the operation panel controller 116 displays the save destination confirmation screen 801 on the display 18 of the operation panel 19 (step S104).

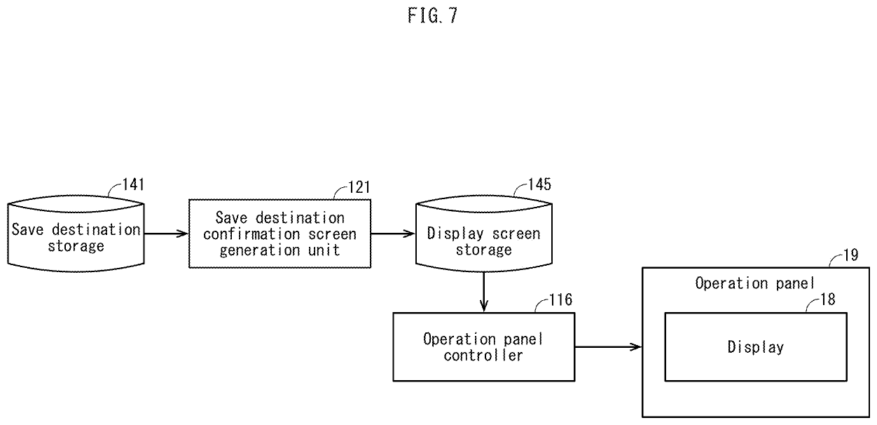

FIG. 7 is a block diagram illustrating functional structure pertaining to generation and display of a save destination confirmation screen in the image forming device 10. As illustrated, the save destination confirmation screen generation unit 121 acquires the save destination information 504 from the save destination information storage 141, and generates the save destination confirmation screen 801, which is for confirming which operation to execute among a plurality of options including saving the scan data to a save destination indicated in the save destination information 504. In FIG. 8, a button 802 is for accepting an operation to save the scan data to the save destination indicated by the save destination information 504. A button 803 is for accepting an operation to save the scan data to a user's “Box”, and a button 804 is for accepting an operation to print the scan data using the printer 12. The operations accepted by the buttons 803, 804 are examples of operations that might be performed with respect to scan data when a scan instruction is received by the operation panel 19 and a scan job is executed. A button 805 is for accepting an operation to cancel the remote scan instruction. The buttons 802-805 illustrate examples of operations, and of course a touch pad or the like may be used.

Returning to FIG. 4, upon receiving selection by a user, via the operation panel 19, of an operation to save scan data to the save destination indicated by the save destination information 504 (“Yes” in step S105), the scan data transmission unit 123 transmits the scan data stored in the scan data storage 144 to the save destination indicated by the save destination information 504 (step S106).

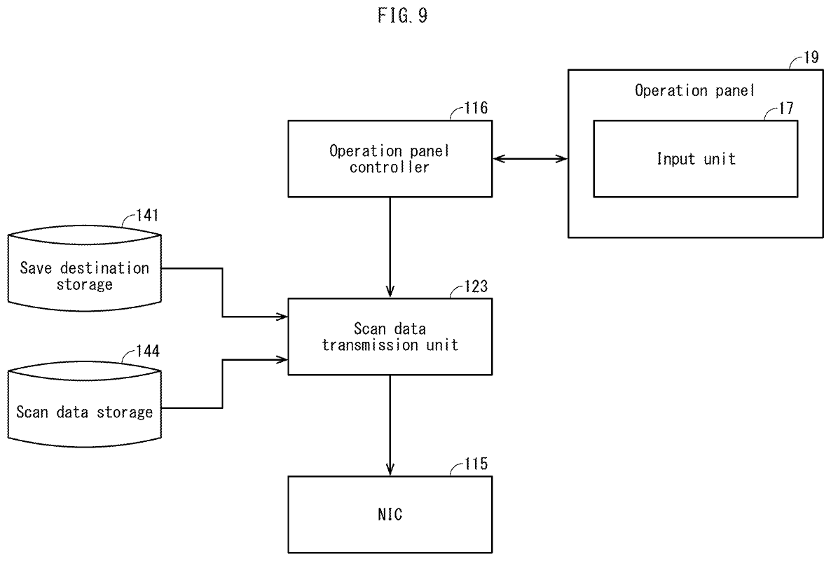

FIG. 9 is a block diagram illustrating functional structure pertaining to transmission of scan data by the scan data transmission unit 123. When the operation panel 19 receives input from a user selecting an operation to save scan data to the save destination indicated by the save destination information 504, the scan data transmission unit 123 is notified of the received input via the operation panel controller 116. Upon receiving the notification, the scan data transmission unit 123 sets the save destination indicated by the save destination information 504 as a transmission destination, generates transmission packet data with the scan data stored in the scan data storage 144 set as a payload, and transmits the transmission packet data via the NIC 115.

Returning to FIG. 4, when the operation panel 19 receives input from a user selecting an operation other than the operation to save scan data to the save destination indicated by the save destination information 504 (“Yes” in step S107), the image forming device 10 performs corresponding processing, then deletes the scan data stored in the scan data storage 144 and discards the remote scan instruction (step S108). Here, the “corresponding processing” may be saving the scan data stored in the scan data storage 144 to a “Box”, printing via the printer 12, or the like.

The main controller 110 sets a timeout for accepting a panel operation selecting any of the buttons 802-805 of the save destination confirmation screen 801 displayed on the display 18. That is, the main controller 110 accepts a panel operation selecting any of the buttons 802-805 prior to the timeout, but if a defined time passes without reception of a panel operation selecting any of the buttons 802-805, the timeout occurs and processing proceeds to step S110.

As illustrated in FIG. 8, the save destination confirmation screen 801 includes an area 806 displaying time until the timeout, and the save destination confirmation screen generation unit 121 updates the area 806 displaying time until the timeout according to time passed. According to the present embodiment, an initial value of the timeout is 60 seconds, but any time may be set.

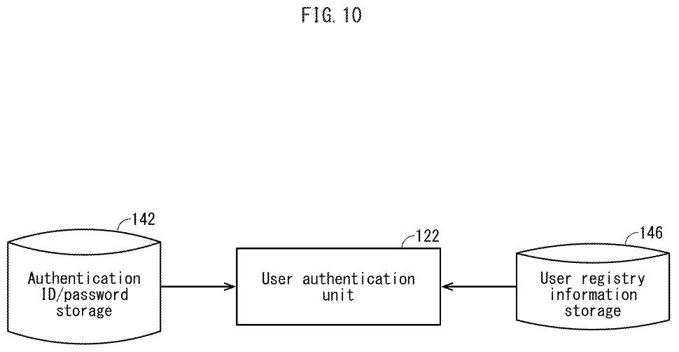

Returning to FIG. 4, after the timeout, the user authentication unit 122 determines whether or not the remote scan instruction is from an authorized user (step S110). FIG. 10 is a block diagram illustrating functional structure pertaining to user authentication by the user authentication unit 122. The user authentication unit 122 determines whether or not the remote scan instruction is from an authorized user according to whether or not user registration information stored in the user registration information storage 146 matches up with the authentication ID and password stored in the authentication ID/password storage 142. If the remote scan instruction does not include an authentication ID and password, the user authentication unit 122 determines that the remote scan instruction is not from an authenticated user.

Returning to FIG. 4, when it is determined that the remote scan instruction is from an authenticated user (“Yes” in step S110), the scan data transmission unit 123 unconditionally transmits the scan data stored in the scan data storage 144 to the save destination indicated by the save destination information 504 (step S111).

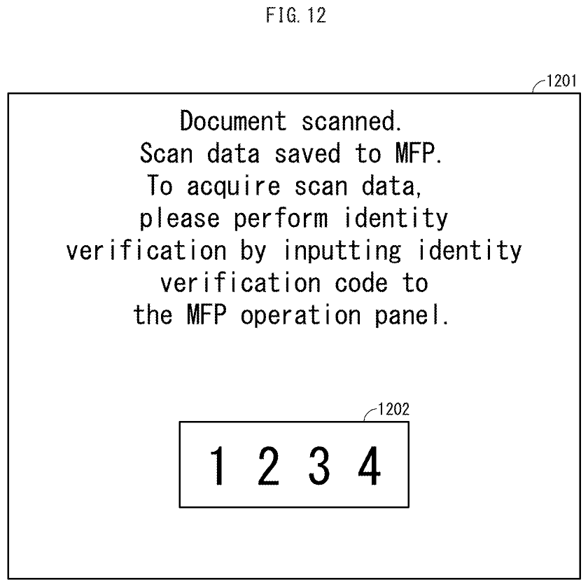

On the other hand, when it is determined that the remote scan instruction is not from an authenticated user (“No” in step S110), the substitute image generation unit 124 generates a substitute image 1201, an example of which is illustrated in FIG. 12, and transmits the substitute image 1201 to the save destination indicated by the save destination information 504.

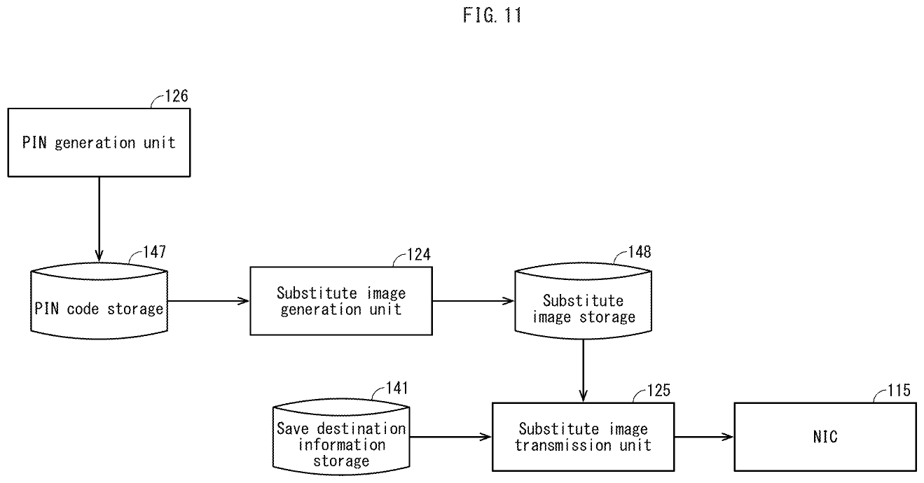

FIG. 11 is a block diagram illustrating functional structure pertaining to generation and transmission of a substitute image in the image forming device 10. The PIN generation unit 126 has a function of generating a PIN code for identity verification, which is stored in the PIN code storage 147. The PIN code is a random 4 digit number, for example. The substitute image generation unit 124 generates data of the substitute image 1201 using the PIN code stored in the PIN code storage 147 and stores the data in the substitute image storage 148. As illustrated in FIG. 12, the substitute image 1201 shows an area 1202 in which the PIN code stored in the PIN code storage 147 is displayed, and describes at least a portion of an operation procedure to output the scan data stored in the image forming device 10 from the image forming device 10.

The substitute image transmission unit 125 sets the transmission destination to the save destination indicated by the save destination information 504, generates transmission packet data setting the data of the substitute image 1201 stored in the substitute image storage 148 as a payload, and transmits the generated transmission packet data via the NIC 115.

Operations of the image forming system 1 after transmission of the substitute image are described with reference to FIG. 13.

The image forming device 10 receives input of a PIN code from a user via the input unit 17 of the operation panel 19 and performs identity verification using the received PIN code (step S201).

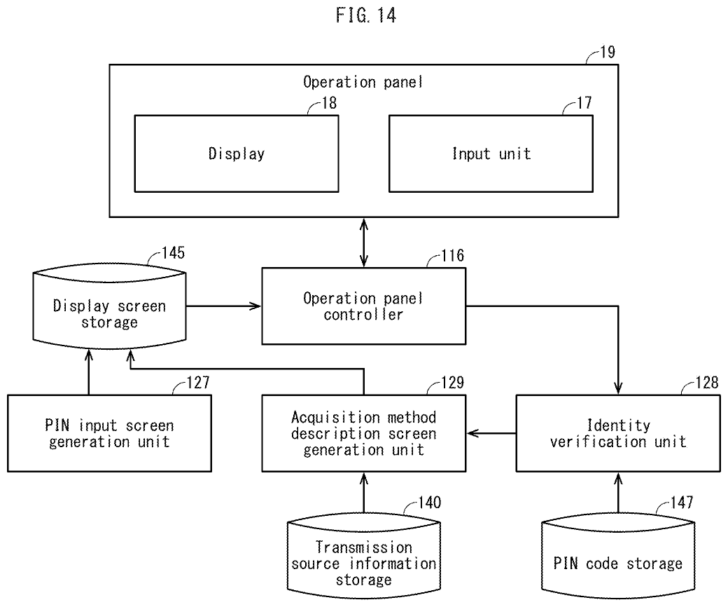

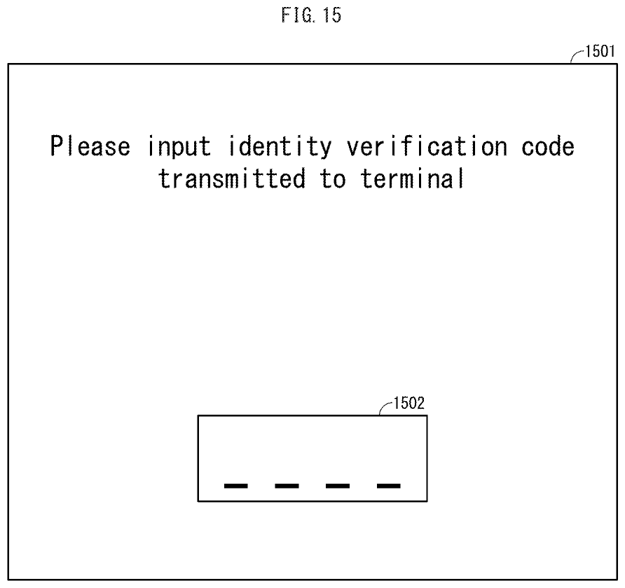

FIG. 14 is a block diagram illustrating functional structure pertaining to identity verification in the image forming device 10. In identity verification processing, the PIN input screen generation unit 127 generates a PIN input screen 1501, an example of which is illustrated in FIG. 15, and stores the PIN input screen 1501 in the display screen storage 145. The operation panel controller 116 causes the display 18 to display the PIN input screen 1501 stored in the display screen storage 145 and accepts input of a PIN code from a user via the input unit 17. When a user inputs a PIN code to the input unit 17, the identity verification unit 128 is notified of the PIN code entered, via the operation panel controller 116. The identity verification unit 128 compares the PIN code entered by the user to the PIN code stored in the PIN code storage 147, and performs identity verification based on whether or not they match.

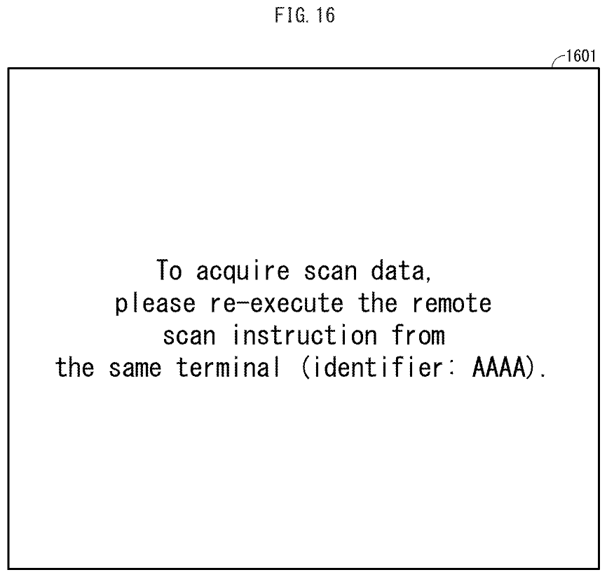

When identity verification using the PIN code is successful, the acquisition method description screen generation unit 129 generates an acquisition method description screen 1601, an example of which is illustrated in FIG. 16, and stores the acquisition method description screen 1601 in the display screen storage 145. The operation panel controller 116 causes the acquisition method description screen 1601 stored in the display screen storage 145 to be displayed on the display 18. According to the present embodiment, the method for acquiring the scan data stored in the image forming device 10 after successful identity verification is to perform the remote scan instruction again on the terminal that previously issued the remote scan instruction. Thus, the acquisition method description screen generation unit 129 causes the acquisition method description screen 1601 to show an identifier of the terminal that was the transmission source, read from the transmission source information storage 140, and a message indicating that the remote scan instruction be performed again from the same terminal.

Returning to FIG. 13, after displaying the acquisition method description screen 1601 on the display 18, the image forming device 10 accepts a remote scan instruction from a user (step S202).

The transmission source information comparison unit 130 compares transmission source information of a received remote scan instruction with the transmission source information of the prior remote scan instruction. The transmission destination may be the save destination indicated in the save destination information included in the remote scan instruction received in step S202.

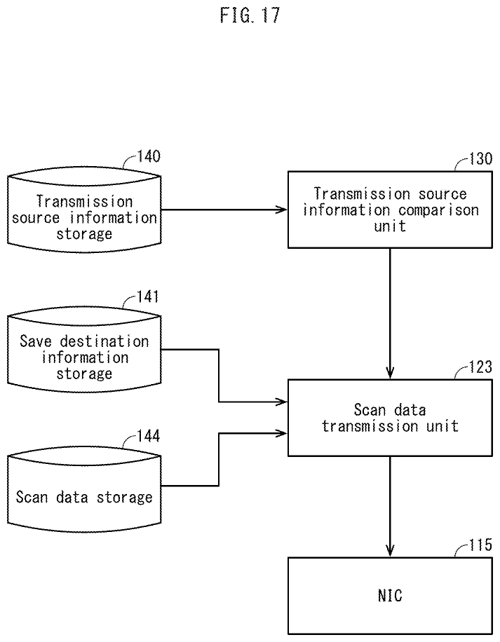

FIG. 17 is a block diagram illustrating functional structure pertaining to scan data transmission in the image forming device 10.

The transmission source information included in the remote scan instruction received in step S202 is stored in the transmission source information storage 140 as in the case of the prior remote scan instruction. The transmission source information comparison unit 130 reads out from the transmission source information storage 140 the transmission source information 503 included in the prior remote scan instruction and the transmission source information included in the remote scan instruction received in step S202, and compares the two. When the two match, the scan data transmission unit 123 sets the save destination indicated by the save destination information 504 as a transmission destination, generates transmission packet data with the scan data stored in the scan data storage 144 set as a payload, and transmits the transmission packet data via the NIC 115.

When the transmission source information 503 included in the prior remote scan instruction is different from the transmission source information included in the remote scan instruction receive in step S202, the prior remote scan instruction is cancelled, the scan data stored in the scan data storage 144 is deleted, and step S202 is replaced with step S102 to continue processing.

In this way, the image forming system 1 pertaining to the present embodiment executes remote scan processing.

### 1.6. Review

According to the image forming system 1 pertaining to the present embodiment, when a remote scan instruction is executed, the save destination confirmation screen 801 including a save destination in the remote scan instruction is displayed on the display 18 of the operation panel 19. If the person executing the remote scan and the user who set a document on the image forming device 10 are different, it is assumed that the user who set the document on the image forming device 10 is trying to scan the document by operating the operation panel 19. At such time, the user operating the operation panel 19 does not miss the save destination confirmation screen 801 displayed on the display 18, and therefore can understand that another person is trying the acquire the scan data of the document by performing a remote scan. Accordingly, the user can prevent unauthorized acquisition of the scan data by inputting to the operation panel 19 a selection of an operation other than an operation to save to the save destination of the remote scan.

If the person executing the remote scan and the user who set a document on the image forming device 10 are the same person, the user operates the operation panel 19 to select the operation to save to the save destination of the remote scan, thereby successfully acquiring the scan data.

If the person executing the remote scan and the user who set the document on the image forming device 10 are the same person, and that person is far away from the image forming device 10, it becomes necessary to wait for the timeout of the save destination confirmation screen 801 to confirm the save destination. If the person executing the remote scan is an authenticated user, the scan data can be acquired without performing any operation after the timeout. If the person executing the remote scan is an unauthenticated user, a substitute image describing at least a portion of an operation procedure for outputting the scan data from the image forming device 10 is acquired instead of the scan data, and the scan data can be acquired by following the operation procedure described in the substitute image.

According to the present embodiment, the method for acquiring the scan data stored in the image forming device 10 after successful identity verification is to perform the remote scan instruction again on the terminal that previously issued the remote scan instruction. This is because it is assumed that the scan data is to be used by an application running on the communication terminal 20 or the portable terminal 30. By performing the remote scan instruction again, the application can acquire the scan data using a remote scan function protocol provided by the OS of the communication terminal 20 or the portable terminal 30.

### 2. Supplement

The present disclosure describes an embodiment, but is of course not limited to the embodiment described above, and the following modifications are included in the technical scope of the present disclosure.

(1) According to an embodiment described above, PIN code input is used to confirm whether or not the person who set a document and the person who executed a remote scan are the same person. However, methods of confirming whether or not the person who set a document and the person who executed a remote scan are the same person are not limited to this example.

For example, it may be determined that the person who set the document and the person executing the remote scan are the same person by the following process: causing the same document to be scanned again, comparing image features of the scan data acquired by the prior scan (old scan data) to scan data acquired by the subsequent scan (new scan data), and when the image features match, or are within a predefined range of difference, determining that the document is the same in each instance. When a remote scan instruction is an instruction to scan a plurality of pages of a document at one time, the image feature comparison may be performed with respect to one page or the like. As an image feature, red green blue (RGB) pixel values may be compared, or values calculated using an algorithm such as scale-invariant feature transform (SIFT) or speeded up robust features (SURF) may be compared.

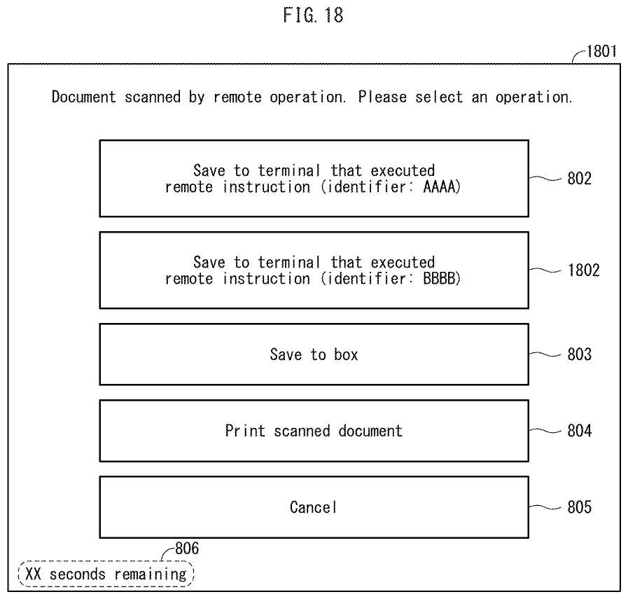

(2) According to an embodiment described above, a situation is described in which another person performs a remote scan when the owner of a document attempts to perform a scan via the operation panel 19 after setting the document. However, the technology can also be applied when another performs a remote scan when the owner of a document performs a remote scan in front of the image forming device 10 after setting the document. This situation can be detected by reception of another remote scan instruction when the save destination confirmation screen 801 is displayed on the display 18. At such time, the save destination confirmation screen generation unit 121 generates a save destination confirmation screen 1801, an example of which is illustrated in FIG. 18, and the operation panel controller 116 causes the display 18 to display the save destination confirmation screen 1801 instead of the save destination confirmation screen 801. The save destination confirmation screen 1801 displays options for operations saving scan data to save destinations corresponding to the two remote scan instructions, as illustrated by buttons 802, 1802. The owner of the document who is in front of the image forming device 10 can compare the two save destinations displayed on the display 18, and can successfully acquire the scan data by inputting an appropriate selection to save to the correct save destination.

(3) According to an embodiment described above, a method of outputting scan data from the image forming device 10 after successful identity verification using a PIN code is to execute a remote scan instruction from the same terminal again, but the present disclosure is not limited to this example. For example, the image forming device 10 may request that a user input an email address via the operation panel 19, and transmit an email with the scan data attached to the email address inputted. The image forming device 10 may store an email address of an authenticated user, and may transmit an email with the scan data attached thereto to an email address selected from stored email addresses. According to this method, a user can acquire scan data by receiving an email with scan data attached by using the communication terminal 20 or the portable terminal 30.

Further, the image forming device 10 may upload scan data to a defined upload server, and display a download uniform resource locator (URL) on the display 18 of the operation panel 19. According to this method, the user can access the defined upload server according to the URL displayed on the display 18 of the operation panel 19 using the communication terminal 20 or the portable terminal 30, and acquire the scan data by downloading the uploaded scan data. The URL may be displayed in other forms such as a QR code (registered trademark).

When a file server accessible by the image forming device 10 is connected to the network 40, the scan data may be saved to the file server, and a message indicating that the scan data is saved to the file server may be displayed on the display 18 of the operation panel 19. According to this method, a user can acquire the scan data by operating the communication terminal 20 or the portable terminal 30 to access the file server and copy the saved scan data to the communication terminal 20 or the portable terminal 30.

The image forming device 10 may accept a panel operation selecting a method out of the methods described above from a user via the input unit 17 of the operation panel 19, and the user can acquire the scan data by the method selected.

(4) According to an embodiment described above, when the process for confirming save destination times out and a remote scan instruction is not from an authenticated user, the substitute screen 1201 is generated and transmitted instead of scan data, but the present disclosure is not limited to this example. For example, when it is possible for a remote scan protocol to output an error message when a scan job fails, the person who executed the remote scan may be notified of a scan data acquisition method by outputting the scan data acquisition method and PIN code as such an error message.

(5) If a document owner and a person who executed a remote scan are not the same person, the owner of the document in front of the image forming device 10 might be confused by display of the save destination confirmation screen 801 and perform no operation until the timeout. At such time, it may be considered that the document owner again sets the document and executes a scan job. When a scan job is executed again before an operation procedure described by the substitute image 1201 is performed, the image forming device 10 compares image features of scan data acquired by the prior scan (old scan data) with scan data acquired by the subsequent scan (new scan data). If the image features match or if a difference in image features is within a defined range, the scans are determined to be of the same document, the prior remote scan instruction is considered to be an unauthorized scan instruction, and the subsequent scan instruction is considered to be an authorized scan instruction. Even if the operation procedure described in the substitute image 1201 is executed, the old scan data is not output from the image forming device 10 and the old scan data stored in the scan data storage 144 is deleted. Thus, theft of document data by unauthorized remote scan instructions can be prevented.

(6) As described above, an image forming device and a portable terminal are computer systems each including a microprocessor and memory. The memory may store a computer program, and the microprocessor may operate according to the computer program.

Here, a computer program combines a plurality of instruction codes indicating instructions for a computer to achieve a defined function.

Further, a computer program may be recorded on a computer-readable recording medium such as a flexible disk, a hard disk, an optical disk, or a semiconductor memory.

Further, a computer program may be transmitted by wired or wireless telecommunication lines, a network such as the Internet, data broadcasting, or the like.

(7) Any embodiment described above and any modification may be combined.

### 3. Supplement 2

The following describes an image reading device and a method reflecting aspects of the present disclosure.

An image reading device reflecting one aspect of the present disclosure is an image reading device that connects to a network, the image reading device including: an operation panel that has a display; a document reader that generates scan data by reading a document placed on a document plate when a scan instruction specifying a save destination is received from an information terminal via the network; and a controller. The controller causes display of the save destination on the display, ready to receive a panel operation via the operation panel to execute a process for transmitting the scan data to the save destination, and upon receiving the panel operation, executes the process for transmitting the scan data to the save destination.

According to an embodiment, the controller: causes display of options for executing a plurality of processes on the display, including the process for transmitting the scan data to the save destination, and deletes the scan data without transmitting the scan data to the save destination when the operation panel receives selection of an option to execute a process other than the process for transmitting the scan data to the save destination.

According to an embodiment, the controller sets a timeout for accepting the panel operation and after the timeout, upon determining that the scan instruction is from an authorized user, executes the process for transmitting the scan data to the save destination.

According to an embodiment, the controller sets a timeout for accepting the panel operation and after the timeout, upon determining that the scan instruction is from an unauthorized user, generates image data or a message describing at least a portion of an operation procedure to output the scan data from the image reading device and executes a process for transmitting the image data or the message to the save destination.

According to an embodiment, the controller, when a new scan instruction is received via the operation panel prior to execution of the operation procedure, determines whether or not image features of the scan data based on the prior scan instruction match scan data based on the new scan instruction, and upon determining that there is a match, does not output the scan data from the image reading device even if the operation procedure is executed.

According to an embodiment, the operation procedure includes verifying that an authentication code in the image data matches an authentication code inputted to the operation panel.

According to an embodiment, the operation procedure includes re-reading at least a portion of the document of the scan data.

According to an embodiment, the operation procedure includes re-transmitting a scan instruction from the information terminal to the image reading device.

According to an embodiment, the operation procedure includes a panel operation of selecting one output method from a plurality of output methods, and the plurality of output methods includes (1) transmitting an email with the scan data attached, (2) uploading the scan data to a defined upload server, and (3) saving the scan data to a defined file server.

According to an embodiment, the information terminal is defined as a first information terminal and the save destination is defined as a first save destination, and the controller, while ready to receive a panel operation, upon receiving a scan instruction specifying a second save destination different from the first save destination from a second information terminal different from the first information terminal, in addition to the option to execute the process for transmitting the scan data to the first save destination, causes display of an option to execute a process for transmitting the scan data to the second save destination, ready to receive selection of either option via the operation panel.

An image reading method reflecting one aspect of the present disclosure is an image reading method executed by an image reading device that includes an operation panel that has a display, a document reader, and a controller, and has a function of connecting to a network. The method includes: the document reader generating scan data by reading a document placed on a document plate when a scan instruction specifying a save destination is received from an information terminal via the network; the controller causing display of the save destination on the display, ready to receive a panel operation via the operation panel to execute a process for transmitting the scan data to the save destination; and the controller, upon receiving the panel operation, executing the process for transmitting the scan data to the save destination.

Although one or more embodiments of the present disclosure have been described and illustrated in detail, the disclosed embodiments are made for the purposes of illustration and example only and not limitation. The scope of the present disclosure should be interpreted by the terms of the appended claims

As used herein, the words “can” and “may” are used in a permissive (i.e., meaning having the potential to), rather than mandatory sense (i.e., meaning must). The words “include,” “includes,” “including,” and the like mean including, but not limited to. Similarly, the singular form of “a” and “the” include plural references unless the context clearly dictates otherwise. And the term “number” shall mean one or an integer greater than one (i.e., a plurality).

What is claimed is:

1. An image reading device that connects to a network, the image reading device comprising:
an operation panel that has a display;
a document reader that generates scan data by reading a document placed on a document plate, when a scan instruction specifying a save destination is received from an information terminal via the network; and
a controller that (i) causes display of the save destination on the display, which is ready to receive a panel operation via the operation panel to execute a process for transmitting the scan data to the save destination, and, (ii) upon receiving the panel operation, executes the process for transmitting the scan data to the save destination.

2. The image reading device of claim 1, wherein the controller:
causes display of options for executing a plurality of processes on the display, including the process for transmitting the scan data to the save destination, and
deletes the scan data without transmitting the scan data to the save destination when the operation panel receives selection of an option to execute a process other than the process for transmitting the scan data to the save destination.

3. The image reading device of claim 1, wherein the controller sets a timeout for accepting the panel operation and after the timeout, upon determining that the scan instruction is from an authorized user, executes the process for transmitting the scan data to the save destination.

4. The image reading device of claim 1, wherein the controller sets a timeout for accepting the panel operation and after the timeout, upon determining that the scan instruction is from an unauthorized user, generates image data or a message describing at least a portion of an operation procedure to output the scan data from the image reading device and executes a process for transmitting the image data or the message to the save destination.

5. The image reading device of claim 4, wherein the controller, when a new scan instruction is received via the operation panel prior to execution of the operation procedure, determines whether image features of the scan data based on the prior scan instruction match scan data based on the new scan instruction, and upon determining that there is a match, does not output the scan data from the image reading device even if the operation procedure is executed.

6. The image reading device of claim 4, wherein the operation procedure includes verifying that an authentication code in the image data matches an authentication code inputted to the operation panel.

7. The image reading device of claim 4, wherein the operation procedure includes re-reading at least a portion of the document of the scan data.

8. The image reading device of claim 4, wherein the operation procedure includes re-transmitting a scan instruction from the information terminal to the image reading device.

9. The image reading device of claim 4, wherein the operation procedure includes a panel operation of selecting one output method from a plurality of output methods, and
wherein the plurality of output methods includes (1) transmitting an email with the scan data attached, (2) uploading the scan data to a defined upload server, and (3) saving the scan data to a defined file server.

10. The image reading device of claim 1, wherein the information terminal is defined as a first information terminal and the save destination is defined as a first save destination, and
wherein the controller, while ready to receive a panel operation, upon receiving a scan instruction specifying a second save destination different from the first save destination from a second information terminal different from the first information terminal, in addition to the option to execute the process for transmitting the scan data to the first save destination, causes display of an option to execute a process for transmitting the scan data to the second save destination, ready to receive selection of either option via the operation panel.

11. An image reading method executed by an image reading device that includes an operation panel that has a display, a document reader, and a controller, and has a function of connecting to a network, the method comprising:
generating, via the document reader, scan data by reading a document placed on a document plate, when a scan instruction specifying a save destination is received from an information terminal via the network;
causing, via the controller, display of the save destination on the display, which is ready to receive a panel operation via the operation panel to execute a process for transmitting the scan data to the save destination; and
upon receiving the panel operation, executing, via the controller, the process for transmitting the scan data to the save destination.
